(19) United States
(12) Patent Application Publication
(10) Pub. No.: US 2019/0160602 A1
(43) Pub. Date: May 30, 2019

(54) METHOD FOR MANUFACTURING A STEEL PART, INCLUDING THE ADDITION OF A MOLTEN METAL TO A SUPPORTING PART, AND PART THUS OBTAINED

(71) Applicant: APERAM, Luxembourg (LU)

(72) Inventors: Pierre-Olivier SANTACREU, ISBERGUES (FR); Aurélien BUTERI, BETHUNE (FR); Jérôme BRIDEL, BETHUNE (FR)

(21) Appl. No.: 16/321,741

(22) PCT Filed: Aug. 3, 2016
(86) PCT No.: PCT/IB2016/054686

§ 371 Date: Jan. 29, 2019

(51) Int. Cl. B23K 35/30; B23K 35/02; B23K 26/342; C22C 38/00; C22C 38/02; C22C 38/04; C22C 38/44; C22C 38/46; C22C 38/42; C22C 38/48; C22C 38/50; C22C 38/52; C22C 38/54; C22C 38/60

(52) U.S. Cl. CPC B23K 35/3086; C22C 38/60; B23K 26/342; C22C 38/001; C22C 38/02; C22C 38/04; C22C 38/44; C22C 38/46; C22C 38/42; C22C 38/48; C22C 38/50; C22C 38/52; C22C 38/54; C22C 38/008; B23K 35/0244

(57) ABSTRACT

A method of manufacturing a steel part including a support part and a portion formed by a filler metal in the form of molten metal on the support part to form a heat affected zone and a molten zone between the HAZ and the portion formed by adding molten metal. The support part is made of a 70-100% martensitic microstructure steel, the composition of which consists of defined percentages of: C; N; Mn; Si; Al; S+P; Cr; Ni; Mo+W; Cu; Ti+Nb+Zr+V+Ta; Co; Sn+Pb; and B; the remainder being iron. The composition of the filler metal before use consists of defined percentages of: C; N; Mn; Si; Cr; Ni; Mo+W; Cu; Co; B; S+P; Ti+Nb+Zr+V+Ta; Sn+Pb; the remainder being iron.

The present invention relates to metallurgy, and more specifically to the manufacture of stainless steel solid parts from steel sheets, wherein they have localized material additions, such as reinforcing elements, which are deposited after the eventual shaping of the sheets.

The manufacture of steel parts by hot or cold forming (forging, molding, stamping, drawing, etc.) may contribute to parts of more or less complex shapes. It may happen, and we will see examples in the following description, that after their forming these parts have a geometry that makes them comprise areas where their mechanical characteristics are insufficient for an intended application. Accordingly, they would need to be reinforced by the local presence of greater thickness, or ribs, or other types of configuration with a similar function.

Introducing such greater thicknesses or reinforcing elements might be considered during the forming of the part itself, in order to make it in one piece. However, this is not always possible for parts with relatively complex shapes and very precise dimensions, or with a complexity in the manufacturing method (multiplication of the forming steps, and/or the need to carry out significant final machining in order to obtain the desired configuration and precise dimensions), which would make the production cost unacceptable for large series parts.

However, it is highly desirable to have such parts that are only reinforced where necessary, because only relatively small thicknesses need to be applied to the major portion of their volume in order to thus save material, and therefore cost and weight, which are advantageous, for example for automotive parts such as structural elements, suspension arms . . . . This may also allow expansion of the choice of the main material of the part, by taking into account relatively simple configurations of the initial part (which will be referred to as the “support part” in the rest of the text) that is not yet reinforced locally to allow this method to be implemented, wherein the mechanical properties of the material in use would be the main criterion for this choice, while the ability of the material to be formed in a complex way may no longer be a critical criterion in the choice.

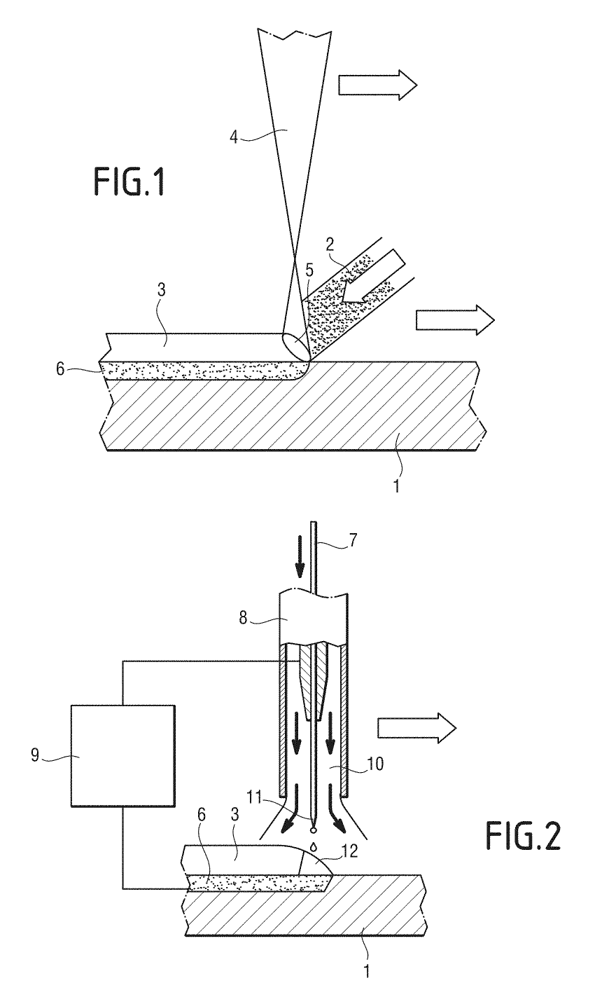

It has therefore already been proposed to make these locally added reinforcing elements through the direct deposition of molten metal on an initially formed support part. This deposition may be carried out, typically and in particular, by using a laser, an electron beam or an electric arc, which are methods that melt the filler material just before or after the instant of its contact with the support metal. The latter is initially in the form of powder, wire or tape. FIGS. 1 and 2 (discussed below) show the general principles of two such methods (jet of powder melted by laser and wire melted by electric arc). From certain points of view, these are similar to welding by a method involving the contribution of material by metallurgical mechanisms that are brought into play, in particular for the joining of the support part and the reinforcing element, and, in other respects, to 3D printing, with a supply of metallic material that is intended to give the reinforcing elements precise shapes and dimensions.

It is thus possible to give the greater part of the support part a minimum necessary thickness, combined with a manufacturing method that is as simple as possible (drawing, for example). This support part is only completed a posteriori by means of reinforcing elements that are affixed and which themselves are formed by a relatively inexpensive deposition method, and are dimensioned in order to give the support part only minimal additional weight. Typically, the addition of reinforcing elements in the form of ribs or, in general, stiffeners, of the order of 1 mm thick, is possible, which would not be possible, or not easily, by means of monobloc forming methods of the final piece such as forging or molding.

However, it should be remembered that like any thermal method, the addition of molten metal onto the support part thermally affects a portion of the thickness of the support part in the vicinity of its surface, i.e. in the deposition zones of the molten metal. This Heat Affected Zone (HAZ), as found in material-fed welding methods, is modified in two ways:
There is creation of a diffusion zone of the filler metal in the support part (and vice versa), and it is necessary to control this diffusion so that it does not have negative consequences on the properties of the final part;
In, and in the vicinity of, this diffusion zone, there is a modification of the microstructure of the support part, which may also have adverse effects on the properties of the final part.

Specifically, in the case where this method of adding molten metal to a support part made of a steel with high mechanical properties obtained by the strong presence of martensite is implemented, a significant degradation of the mechanical characteristics is observed in the HAZ, mainly in the form of a loss of hardness due to a softening of the microstructure. This softening is related to a grain enlargement and/or a metallurgical transformation consisting of a transformation of the martensite of the support part into ferrite and carbides. This is called the reversion of martensite. In addition, significant residual stresses may be set up in the portion that has undergone the treatment, because of the different expansion characteristics of the various zones and materials that are involved.

A problem of fragility of the stiffening elements thus added also arises frequently. When the part is stressed by bending or torsion, it is the portions that undergo the strongest constraints. Minimal mechanical strength for the deposited metal is required, which is not always the case with solidification structures obtained when using molten metal addition methods.

The object of the invention is to propose a method for manufacturing a final component comprising a support part and added portions by means of a method for adding molten metal, for example reinforcing elements, which makes it possible to eliminate, or at least strongly limit, the risks of occurrence of the problems mentioned above.

To this end, the object of the invention is a method for manufacturing a final steel part comprising a support part and at least one portion formed by a method for adding a filler metal in the form of molten metal onto a portion of the surface of the support member, thus forming a heat affected zone (HAZ) on the support member and a molten zone between the HAZ and the portion formed by the addition of molten metal, characterized in that:
the support part is made of a chromium steel with a martensitic microstructure of 70-100%, preferably 90-100%, in the quenched or tempered state, while the remainder of the microstructure comprises ferrite, austenite and carbides and/or carbonitrides, wherein the composition, in percentages by weight, consists of:
0.01%≤C≤1.5%;
0.01%≤N≤0.2%;
0.2%≤Mn≤1.2%;
0.2≤Si≤1.2%;
traces≤Al≤0.1%
traces≤S+P≤0.05%;
5.0%≤Cr≤16.5%;
traces≤Ni≤3.5%;
traces≤Mo+W≤2.0%;
traces≤Cu≤3.0%;
traces≤Ti+Nb+Zr+V+Ta≤2%;
traces≤Co≤0.5%;
traces≤Sn+Pb≤0.04%
traces≤B≤0.01%;
the remainder being iron and impurities resulting from the preparation; and meets the conditions:

A=% Mn+% Ni+% Cu+30*(% C+% N)−3*(% Ti+% Nb) 1.5%

B=% Cr+% Mo+5*(Y % V+% W+% Si+% Al 9%;
in that the composition of the filler metal before its use consists of:
0.01%≤C≤0.1%;
0.01%≤N≤0.2%;
0.2%≤Mn≤2.0%;
0.2≤Si≤1.2%;
15.0%≤Cr≤19.0%;
6.0%≤Ni≤13.0%;
traces≤Mo+W≤3.0%;
traces≤Cu≤3.0%;
traces≤Co≤0.5%;
traces≤B≤0.01%;
traces≤S+P≤0.05%;
traces≤Ti+Nb+Zr+V+Ta≤2%; preferably traces≤Ti+Nb+Zr+V+Ta≤1.0%;
traces≤Sn+Pb≤0.04%;
the remainder being iron and impurities resulting from the preparation;
In that the hardness of the HAZ is not less than 20% more than that of the remaining portions of the support part, and the martensite content of the HAZ is greater than or equal to 70%;
and in that the molten zone has a dilution ratio (% Ni (molten metal)−% Ni (support metal))/(% Ni (filler metal)−% Ni (support metal)) of 50 to 95% by weight, preferably 75 to 85% by weight.

The method for adding molten metal may consist in adding molten metal powder by means of a laser beam or an electron beam.

The method of adding molten metal may consist in adding a molten metal from a wire, whose fusion is caused by the production of an electric arc between the wire and the support part, or by a laser or by an electron beam.

The invention also relates to a final steel part characterized in that it is manufactured by the preceding method, and in that at least one of the portions formed by a molten metal addition method is a reinforcement element for the support part.

As will be understood, the invention consists in combining the production of the support part in a martensitic steel with a high Cr content (5.0-16.5%, and thus that is not necessarily a stainless steel) and a determined composition, and the production of the added portions by the addition of molten metal with a metal consisting of a stainless steel with an initial composition (before its use as powder, wire, tape or the like in the method of the invention) that is also previously determined, and that is, surprisingly, very different from that of the metal constituting the support part.

In fact, the added molten metal here is, necessarily, a 15.0-19.0% Cr stainless steel, which often contains more Cr than the metal of the support part. And it also contains between 6.0 and 13.0% of Ni, that is significantly more than the metal of the support part.

The contents of elements other than Cr and Ni that the two steels used must contain, are also well defined.

The invention is therefore based above all on a particular choice of the combination of materials used, which will be seen as being advantageous in the context of the manufacture of a final part by direct deposition of molten metal on a support part.

The invention will be better understood upon reading the description which follows, given with reference to the following appended figures:

FIG. 1 shows schematically the principle of a method of supplying molten metal in the form of a powder made liquid by a laser beam;

FIG. 2 shows schematically the principle of a method of supplying molten metal in the form of a wire whose fusion is achieved by a welding torch;

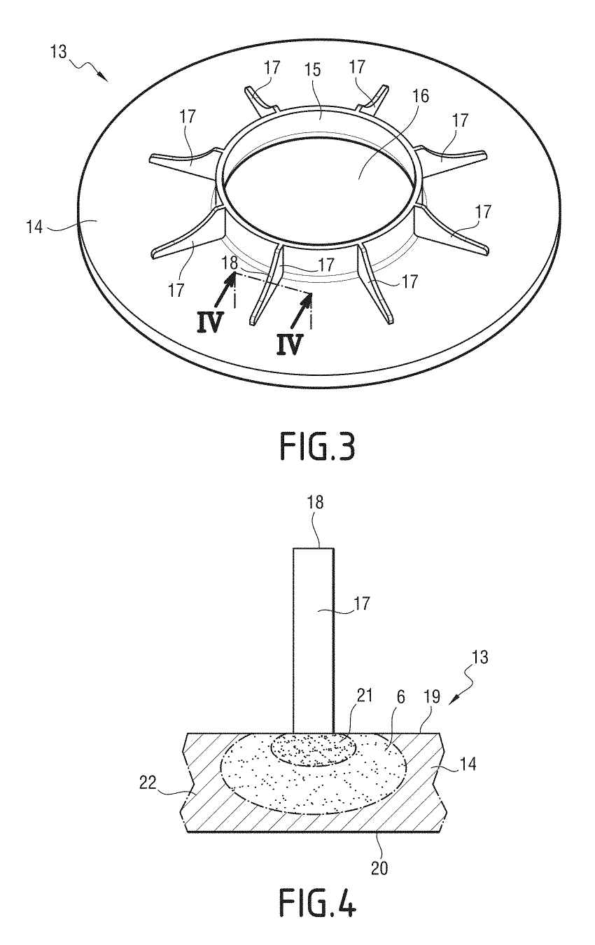

FIG. 3 shows a flange for fixing a tube, provided with stiffeners formed on the circular portion of the flange and on its collar by the method according to the invention;

FIG. 4 shows in cross-section along IV-IV, one of these stiffeners and its contact area with the circular portion of the flange;

FIG. 5 shows the results of Vickers HV1 hardness measurements (NF EN ISO 6507 2006, 1 designating the load in kgf) made on the section of the flange and on one of its stiffeners;

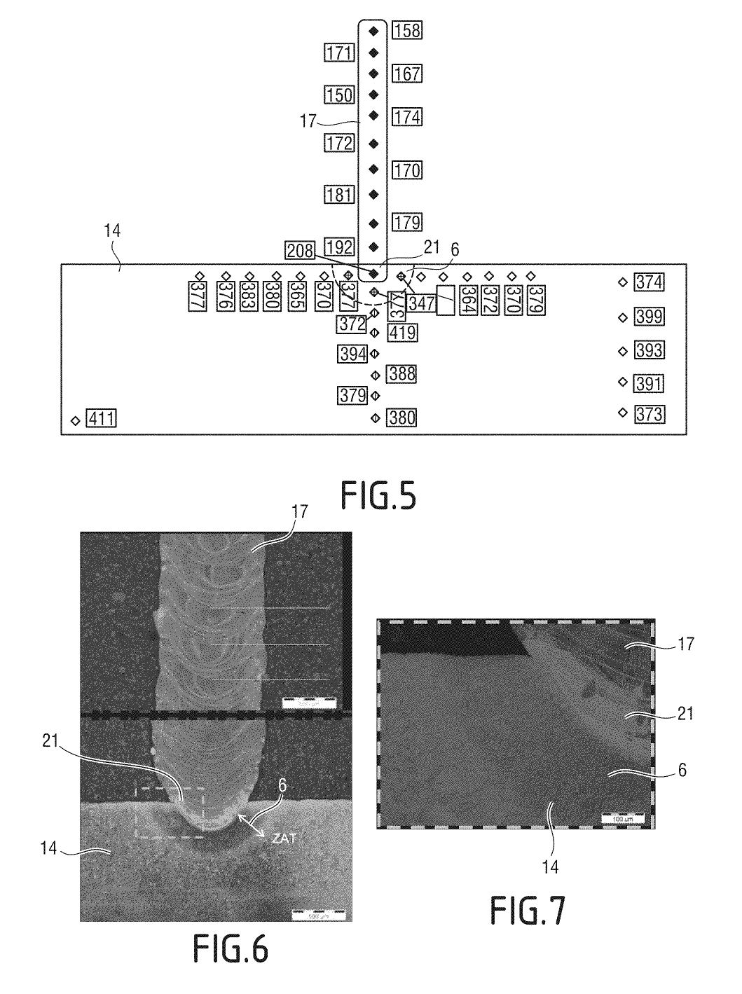

FIG. 6 shows a micrograph of the connection zone between the flange and the stiffener;

FIG. 7 shows a micrograph of a part of this same connection zone, highlighting the HAZ and the molten zone;

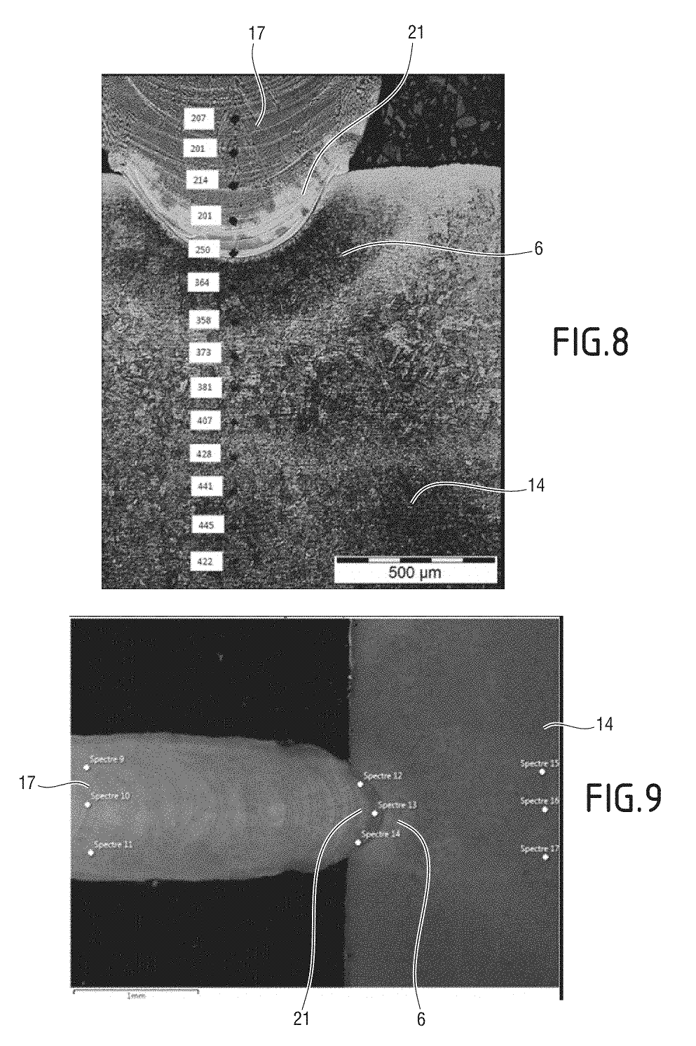

FIG. 8 shows a micrograph of the connection zone between the flange and the stiffener, on which are shown the results of Vickers hardness measurements HVO,1;

FIG. 9 shows a micrograph of the zone of connection between the flange and the stiffener, wherein points have been indicated where measurements of dilution of the material of the stiffener have been made in the material of the flange;

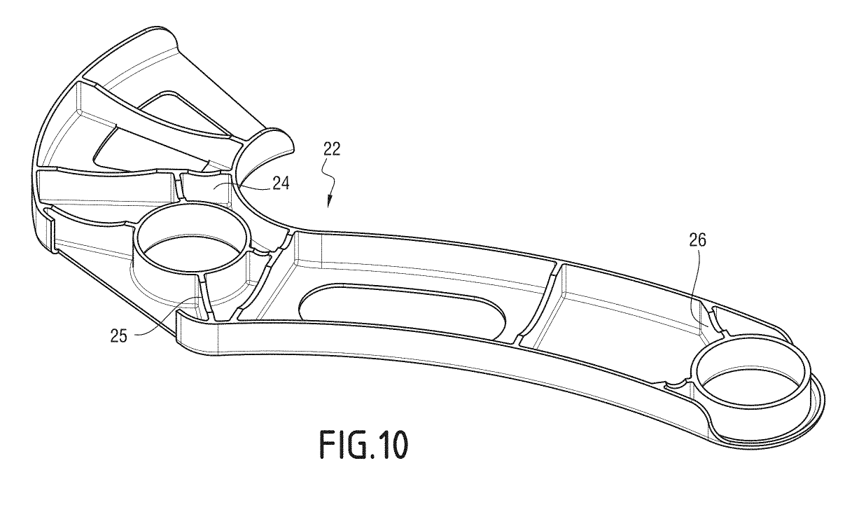

FIG. 10 shows a cut and drawn suspension arm, on which were added stiffeners by the method according to the invention.

FIG. 1 generally represents the principle of 3D printing on a metal support part 1 by adding molten metal, more specifically by melting a metal powder 2 by means of a laser.

The support part 1, i.e. the initial part on which the deposition is to take place, is fixed. A metal powder jet 2 is projected onto its surface by conventional means (not shown), wherein it is intended to constitute the filler metal that will form the deposit 3 after its solidification. The supply source of the powder 2 is moved relative to the surface of the support part 1, in the plane of the figure and from left to right in the example shown. A laser beam 4 is also projected onto the surface of the support part 1 while moving, in order to accompany the movement of the powder jet 2, and to effect melting of the powder 2 deposited on the support metal in the impact zone of the laser beam 4, in order to form a liquid well 5. The laser also causes a partial and very superficial melting of the metal 1. The liquid well, that solidifies when it is no longer in the field of the laser beam 4 that has moved on, forms the deposit 3 whose composition corresponds to that of the powder 2, or that is close to it. This point will be discussed in detail later. Under this deposit 3, there is, in the vicinity of the surface of the support part 1 with a thickness of the order of 300 μm, a heat affected zone (HAZ) 6 whose microstructure is influenced by the contact with the laser beam 4 and the liquid well 5, in a manner that is comparable to that which occurs during material-fed welding, wherein there is a morphology in successive layers that is also qualitatively very similar to that observed during welding by the addition of material.

FIG. 2 generally represents the principle of 3D printing on a metal support part 1 by adding molten metal by means of a welding wire 7 or the like (tape for example), which is unwound in the direction of the support part 1, by means of a welding torch 8 that is, itself, moved relative to the support part 1 in the plane of the figure and from left to right in the example shown. Conventionally, a power supply 9 is connected, on the one hand, to the support part and, on the other hand, to the welding wire 7 via the torch 8, the inner space 10 of which is supplied with a protective gas flowing towards the support part 1. This results in the formation of an electric arc between the end of the wire 7 and the support part 1, so that the welding wire is liquefied at its lower end 11, and the drops of liquid are deposited in superimposed layers (corresponding to drops of liquid coming off the wire 7 onto the support part 1 to form a liquid well 12). This solidifies when it leaves the field of action of the electric arc to form, as in the previous example, a deposit 3 essentially having the composition of the welding wire 7. Here again, the vicinity of the surface of the support part 1 has an HAZ 6 under the deposit 3.

Alternatively, it would also be possible to ensure the fusion of the welding wire 7, or a tape of the same composition, with a laser beam or an electron beam.

It is, of course, very desirable, even essential, that all these operations are automated as far as possible, particularly with regard to the speed of movement of the moving tools and the mass flow of their supply of filler metal, powder, wire, tape or the like, all of which determines the form that the reinforcing elements will adopt.

A layer of filler metal of constant thickness is shown in FIGS. 1 and 2, but this is, of course, not general, as will be seen in other figures.

These methods of adding metal to a support part are known in the prior art, and are only described here as a reminder. In particular, the automation of operations is normal practice in the implementation of this type of method, while the present invention uses it in a manner similar to that which is usually implemented.

Other methods, for example using an electron beam to obtain the melting of the filler metal, are also known, or are conceivable, for this purpose, while the invention is independent, in principle, of the precise choice of the method used.

The invention is based on a particularly advantageous choice of the combination formed by the compositions of the support part 1 on the one hand, and the filler metal on the other hand, wherein it is initially in the form of a powder 2, a wire 7, a tape or the like.

It should be understood that this composition of the filler metal as defined in the invention is that which exists before it is deposited and melted on the support part 1, and therefore does not take into account any modifications, at least local, that this composition could undergo during the operation, such as a recovery of oxygen that would result in the formation of oxidized inclusions and possibly a decarburization, and a recovery of nitrogen. These modifications may occur, in particular, if the operation does not take place in an atmosphere perfectly inert with respect to the liquid metal deposited.

Regarding the metal constituting the support part 1, it must have a high proportion of martensite in its structure at the time of implementation of the method. This proportion should be at least 70%, and preferably between 90 and 100%. In fact, this structure, which is strongly, or very largely, martensitic, provides the support part 1 with high mechanical characteristics, which means that most of the part may be made of a relatively thin material, and that its reinforcement by stiffeners is only necessary locally. The rest of the microstructure, if it is not 100% martensitic, consists of ferrite, austenite and carbides and/or carbonitrides.

In addition, its martensitic transformation start temperature Ms must be less than or equal to 500° C., and the increase in the volume of the metal of the support part 1 during this transformation at a speed of 30° C./s or more, must be between 2 and 6%. This temperature Ms and the associated volume change are not affected by the cooling rate of up to 2° C./s, and the metal 1 is therefore described as self-hardening.

This characteristic is original in that such relatively high expansions occurring during the martensitic transformation are far from being a generality for steels that would probably have been used to produce a part with high mechanical characteristics. This high expansion is made necessary, in the context of the invention, to compensate for the contraction that the liquid well 5, 12 of filler metal will undergo during its solidification, and thus ensure the good continuity of the material forming the deposit 3. The temperature Ms and the associated volume change are preferably determined experimentally, for example, by dilatometric measurements as is well known and described in the Précis de métallurgie by J.Barralis and G. Maeder, AFNOR Nathan ISBN 2-09-194017-8.

The steel forming the support part 1 must also have a strong resistance to softening, resulting in a low diffusion of carburigenic elements and carbon. Concretely, the hardness of the HAZ 6 will not be less than 20% more than that of the remaining portions of the support part 1 that have not been influenced by the molten metal input. This gives a satisfactory homogeneity of the mechanical properties, which are not too degraded in the HAZ 6 with respect to the nominal properties of the support part 1.

FIG. 3 represents a flange 13 for fixing a tube made by the method according to the invention. It consists of a sheet that is preformed by drawing to give it a generally circular portion 14, and is provided with a collar 15 surrounding a central orifice 16. The circular portion 14 and the collar 15 are made integrally during the forming.

As is known, the collar 15 is reinforced by stiffeners 17 (also called “reinforcing elements”) approximately in the shape of a right-angled triangle, and which bear on the outer wall of the collar and on the upper face of the circular portion 14 of the flange 13. As in the example shown, the hypotenuses 18 of the right triangles forming the stiffeners 17 may have, in fact, a concave shape, having a constant or variable curvature. Again, this characteristic is common for such flanges 13 and does not in itself represent part of the invention.

By way of nonlimiting example, the flange 13 has a thickness of 3 mm, its circular portion 14 has a diameter of 145 mm, the orifice 16 has an outside diameter of 62 mm, the collar 15 has a thickness of 15 mm, the stiffeners 17 have a length of 22 mm and a thickness of 0.7 to 1 mm, and the radius of curvature of their hypotenuses is 150 mm.

FIG. 4 shows, in cross-section along the line IV-IV of FIG. 3, one of the stiffeners 17 and its zone of contact with the circular portion 14 of the flange 13. As a result of the molten metal feed that led to the formation of the stiffener 17, the following is found on the circular portion 14, going from the upper surface 19 where the stiffener 17 is, to the lower surface 20 and in front of the stiffener 17:
A “molten zone” 21 which results from the dilution of a portion of the molten metal 5, 12 in the metal 1 of the circular portion 14 of the flange 13, and therefore has, on average, a composition that is intermediate between those of these metals;
An HAZ 6 whose nominal composition is that of the metal of the support part, but within which there may possibly be localized changes related to the possible privileged diffusion of certain elements inside the support part due to the heating during the deposition of molten metal, or to residual diffusion of the molten metal in its upper part; in addition, the metallurgical structure is modified more or less substantially compared to what it was before the molten metal deposition because of the heating associated with this deposition;
And an area 22 corresponding to the remainder of the circular portion 14 of the flange 13, which has not been substantially affected thermally and chemically by the molten metal deposition operation, and has retained its original composition and metallurgical structure.

The inventors have found that according to the invention, the steel of the support part 1 must have the following composition, expressed in percentages by weight, coupled with a microstructure at least strongly martensitic (from 70 to 100% of martensite, better still, 90% to 100% by weight of martensite):
0.01≤% C≤1.5%
0.01% ≤N≤0.2%
0.2% ≤Mn≤1.2%;
0.2≤Si≤1.2%;
traces≤Al≤0.1%
traces≤S+P≤0.05%;
5.0% ≤Cr≤16.5%;
traces≤Ni≤3.5%;
traces≤Mo+W≤2.0%;
traces≤Cu≤3.0%;
traces≤Ti+Nb+Zr+V+Ta≤2%;
traces≤Co≤0.5%;
traces≤Sn+Pb≤0.04%;
traces≤B≤0.01%;
wherein the rest is iron and impurities resulting from the preparation.
In addition, this composition must satisfy the following two relations A and B:

A=% Mn+% Ni+% Cu+30*(% C+% N)−3*(% Ti+% Nb)≥1.5%

B=% Cr+% Mo+5*%V+% W+% Si+% Al≥9%.

In fact, the satisfaction of the relation A is favorable to the accomplishment of the martensitic transformation, while the satisfaction of the condition B, in particular the influence of Si and Mo, is favorable to a good resistance to softening.

The composition of the martensitic steel used for the support 1 according to the invention is justified as follows.

Its C content is between 0.01% and 1.5%.

The minimum content of 0.01% is justified by the need to obtain austenitization when the metal is heated to a temperature above 700° C., and high mechanical properties for martensite. Above 1.5%, the implementation by conventional methods would be limited, and especially the resilience of the support would become insufficient.

Its Mn content is between 0.2 and 1.2%.

A minimum of 0.2% is required to obtain austenitization. Above 1.2% of oxidation, problems are to be feared during the deposition if it is not carried out under a neutral or reducing atmosphere.

Its Si content is between 0.2% and 1.2%.

If may be used as a deoxidizer during the preparation, just like Al, to which it may be added or substituted. A minimum quantity of 0.2% is necessary because the silicon is an element which limits softening of the support 1 when it is affected thermally. Beyond 1.2%, it is considered that it excessively favors the formation of ferrite and thus makes it more difficult to austenitize and obtain a steel of predominantly martensitic structure. In quantities greater than 1.2%, it also weakens the support.

Its S+P content is between traces and 0.05%, in order to guarantee a low contamination of the melted zone 5, 12 and thus to avoid fragility of the molten zone 5, 12.

Its Cr content is between 5.0 and 16.5%. The minimum content of 5.0% is justified to ensure a self-hardening character for the metal support 1. A content greater than 16.5% would make it difficult to austenitize and obtain a predominantly martensitic structure.

Its Ni content is between traces and 3.5%.

An addition of Ni is not essential to the invention. The presence of Ni within the prescribed limit of not more than 3.5% may, however, be advantageous for promoting austenitization. Exceeding the 3.5% limit would however lead to an excessive presence of residual austenite and an insufficient presence of martensite in the microstructure after cooling. It would also pose cost problems.

Its Mo+W content is between traces and 2.0%.

The presence of Mo or W is not essential and Mo need only be present in the form of traces resulting from the preparation. However Mo limits the softening of the martensite of the HAZ during the deposition. Mo and W are favorable for good corrosion resistance. Above 2.0%, austenitization would be hampered and the cost of steel unnecessarily increased.

Its Cu content is between traces and 3.0%, preferably between traces and 0.5%.

These requirements for Cu are conventional for this type of steels. In practice, this means that an addition of Cu is not essential and that the presence of this element may be only due to the raw materials used. A content greater than 0.5%, which would be a voluntary addition, may however help with austenitization. Beyond 3%, cracking problems in the melted zone may occur.

Its Ti+Nb+Zr+V+Ta content is between traces and 2%.

Ti is a deoxidizer, like Al and Si, but its cost and its efficiency that are less than that of Al for an equal added quantity, makes its use generally not very interesting from this point of view. It may be of interest that the formation of Ti nitrides and carbonitrides can limit grain growth and favorably influence certain mechanical properties and weldability. However, this formation may be a disadvantage in the case of the method according to the invention, since Ti tends to hinder the austenitization due to the formation of carbides, while TiN degrades the resilience. A maximum content of 0.5% is therefore not to be exceeded.

V and Zr are also elements that are capable of forming nitrides that degrade the resilience. Zr, like Ti, hinders austenitization and is also a reason to limit its presence.

Nb and Ta are important elements for obtaining good resilience, while Ta improves resistance to pitting corrosion. But since they may interfere with austenitization, they must not be present in quantities exceeding what has just been prescribed.

The condition Ti+Nb+Zr+V+Ta between traces and 2% is the result of all these considerations.

Its Al content is between traces and 0.1%.

Al is used as a deoxidizer during steelmaking. After the deoxidation, It is not necessary that an amount exceeding 0.1% remains in the steel, because there would be a risk of difficulties in obtaining the martensitic microstructure.

Its Co content is between traces and 0.5%. This element is, like Cu, likely to help with austenitization. But it is useless to add more than 0.5%, because austenitization may be assisted by less expensive means.

Its Sn+Pb content is between traces and 0.04%. These elements are not desired because they are harmful for the solidification of the molten zone.

Its B content is between traces and 0.01%.

B is not obligatory, but its presence is advantageous for quenchability. Its addition above 0.01% does not bring significant additional improvement.

Its N content is between 0.01% and 0.2%. It is an element that helps austenitize from 0.01%, but beyond 0.2% it would limit the quenchability.

And, as we have seen and for the reasons that have been given, relations A and B must also be satisfied.

The satisfaction of the conditions on Ms, the expansion during the martensitic transformation and the hardness of the HAZ 6, which we have seen to be important elements for the success of the method according to the invention, automatically result from the coupling between the composition and the microstructure as defined.

According to the invention, the composition of the filler metal 2, 7 that constitutes the molten metal 5, 12, and the deposits 3 forming the reinforcing element(s) 17, must be the following composition:
0.01% ≤C≤0.1%;
0.01%≤N≤0.2%
0.2%≤Mn≤2.0%;
0.2Si≤1.2%;
15.0%≤Cr≤19.0%;
6.0%≤Ni≤13.0%;
traces≤Mo+W≤3.0%;
traces≤Cu≤3.0%;
traces≤Co≤0.5%;
traces≤B≤0.01%;
traces≤S+P≤0.05%;
traces≤Ti+Nb+Zr+V+Ta≤2%; preferably traces≤Ti+Nb+Zr+V+Ta≤1.0%;
traces≤Sn+Pb≤0.04%;
wherein the rest is iron and impurities resulting from the preparation.

As has been said, this relates to the composition of the filler metal 2, 7 in solid (wire, tape . . . ) or pulverulent form before its melting, and its deposition on the support part 1.

It is a stainless steel structure that is at least predominantly austenitic. The preferred condition on the sum Ti+Nb+Zr+V+Ta helps to ensure that this structure will be predominantly austenitic.

This composition must first lead the reinforcing element 17 to fulfill its role correctly when the final part is in use. It must, to this end, offer good ductility resulting in an elongation at break of at least 15%, preferably between 30 and 40%, and a fine metallurgical structure composed essentially of austenite (at least 80%), while the remainder is ferrite and/or carbonitrides with a grain size of less than 300 μm, a good fatigue strength greater than 200 MPa and a good resistance K1c>50 MPa·m^{1/2} to the propagation of cracks between −40° C. and +80° C. (according to the standard ISO 12135).

For uses at temperatures higher or lower than these limits, the composition just mentioned would also be suitable, but it is preferable that the C content is between 0.01 and 0.05% for uses at low temperatures, in order to have a stable austenite and good ductility of the hardening martensite that may be present. For high temperature applications, C levels of 0.04 to 0.1% are preferred in order to improve heat resistance. For high temperatures, AISI 321 steel and AISI 304H steel may be recommended, and AISI 316L steel, AISI 305 steel and AISI 304L steel for low temperatures, or at least steels falling under these classes of nuances and which have, moreover, their precise compositions within the limits mentioned above.

In addition, this composition must guarantee, in conjunction with the choice of the support metal 1, that the expansion of the filler metal 2 or 7 in the support metal 1 can take place under conditions giving access to the results targeted by the invention, in combination with the predominantly austenitic structure (at least 80%) of the molten zone 21. The composition according to the invention meets these criteria.

As has been said, the molten zone 21 is a zone where both metals have been subjected to a dilution step. The filler metal 2 or 7 must represent from 50 to 95% by weight, preferably 75 to 85% by weight.

The dilution ratio is calculated by the following formula:

% Dilution=(% Ni (molten metal 21)−% Ni (Metal support 1))/(% Ni (filler metal 2 or 7)−% Ni (support metal 1)).

Typically, this molten zone 21 extends over a depth of about 200 μm in front of the stiffener 17 in the example shown.

The choice of the composition of the filler metal 2, 7 and the dilution percentage thereof in the metal of the support part 1, which may be controlled, in particular, by the conditions in which the deposition of metal takes place with the particular characteristics of the installation used and determined by simple models and experiments, ensures that the solidification takes place under good conditions leading to a good result, namely a mostly austenitic microstructure but one that may contain ferrite and/or martensite in a lesser quantity (<20%), thus more resilient, which ensures that the stiffener 17 (generally, the deposit 3) can be effective and will not present excessive fragility at its junction with the circular portion 14 of the flange 13 (and, generally, with the support part 1). We will thus not find large fragile ferritic grains, no hot cracking, no sigma phase, while the hardness at this junction is actually less than or equal to 350 HV1. Under this molten zone 21, there is the HAZ 6 with a depth of 300 μm which was referred to previously. Its composition is nominally that of the support part 1 with the reservations that have been stated about a possible diffusion of certain elements such as carbon or nitrogen, which may cause small local variations in composition. Its hardness Hv1 is, however, generally decreased relative to the hardness Hv1 of the remainder of the support part 1, by a maximum of 20%, better by a maximum of 10%. These limits would also be found even if other methods of measuring hardness are used.

This lower hardness of the HAZ 6 relative to the remainder of the support part 1 is due to the heating undergone by the HAZ 6 during the deposition of molten metal in contact with the liquid well 5, 12. When the temperature in the HAZ 6 exceeds about 800° C., some of the martensite may be converted into austenite, and so the microstructure is softened. It would be very detrimental to the mechanical properties of the HAZ 6 for this softening to persist, and it is therefore necessary that during the cooling of the HAZ 6, a predominantly martensitic structure is restored (at least 70% of martensite), wherein this percentage of martensite is preferably higher in the HAZ 6 than in the remainder of the support part 1 in order to obtain a relatively high compressive residual stress state in the HAZ 6. This can be done if the martensitic transformation start temperature Ms of the metal of the support part 1 is less than or equal to 500° C. and greater than 100° C. The result is that the HAZ 6 actually has a compressive residual stress state that is more favorable to the mechanical properties of the flange 13/stiffener assembly 17.

The choice of an austenitic nuance to constitute the stiffener(s) 17, in connection with the martensitic nuance of the support part 1, is motivated by the presence of the molten zone 21 where a diffusion of one metal into the other takes place. The fact that the supply of a solid metal that solidifies in austenite is performed on a solid support having a martensitic structure limits the possibilities of diffusion and ensures that the molten zone 21 will be neither too extensive nor too fragile.

The method of forming stiffeners 17 (or any other form of reinforcing elements) by molten metal deposition generally advantageously allows these reinforcing elements to be left untouched after their solidification, wherein no machining operation or subsequent surfacing is necessary. The good satisfaction of this characteristic largely depends on the precision with which the deposition operation is controlled by the control members. But the known devices for depositing molten metal which have already been described above are quite capable of obtaining this precision, while the implementation of the invention does not pose any more problems than those already encountered and solved by those skilled in the prior art.

FIG. 5 shows the results of hardness measurements made on the section of the flange 13 and a stiffener 17 of FIGS. 3 and 4, as shown in FIG. 4. The materials used are as follows.

For the flange 13, the composition of the metal is as follows:

| C (%) | Mn (%) | P (%) | S (%) | Si (%) | Al (%) | Ni (%) | Cr (%) | Cu (%) | Mo (%) | W (%) |
|---|---|---|---|---|---|---|---|---|---|---|
| 0.102 | 0.35 | 0.022 | 0.0006 | 0.40 | 0.002 | 0.093 | 12.004 | 0.044 | 0.01 | 0.007 |

| Sn (%) | Nb (%) | Ta (%) | V (%) | Ti (%) | Zr (% | Co (%) | Pb (%) | B (%) | N (%) |
|---|---|---|---|---|---|---|---|---|---|
| 0.0002 | 0.106 | traces | 0.10 | 0.007 | 0.005 | 0.019 | 0.0006 | 0.0004 | 0.025 |

where A=3.958 and B=12.923, and the rest is iron and impurities resulting from the preparation. The microstructure is 100% martensitic.

For the stiffener 17, the composition of the metal is as follows, wherein the rest is iron and impurities resulting from the preparation:

| C (%) | Mn (%) | P (%) | S (%) | Si (%) | Al (%) | Ni (%) | Cr (%) | Cu (%) | Mo (%) | W (%) |
|---|---|---|---|---|---|---|---|---|---|---|
| 0.016 | 1.50 | 0.034 | 0.003 | 0.70 | 0.003 | 12.9 | 16.9 | 0.33 | 2.6 | 0.02 |

| Sn (%) | Nb (%) | Ta (%) | V (%) | Ti (%) | Zr (%) | Co (%) | Pb (%) | B (%) | N (%) |
|---|---|---|---|---|---|---|---|---|---|
| 0.01 | 0.01 | 0.009 | 0.075 | 0.009 | 0.01 | 0.21 | 0.0001 | 0.0006 | 0.05 |

Its structure is austenitic to more than 90%, typically 98%, while the rest is delta ferrite. The particle size of the initial powder is between 45 and 90 μm.

The method of forming the stiffener 17 that has been used is the deposition of powder melted by laser beam. A 600 W YAG laser with an argon gas shield was used. The deposition rate is 500 mm/min.

Measurements of the hardness Hv1 were made at different places, 0.2 mm apart and distributed along the axis of the longitudinal section of the stiffener 17, over the height of the circular portion 14 of the flange 13 in the extension of the axis of the stiffener 17, and up to 2 mm below the surface of the circular portion 14 of the flange 13 on either side of the stiffener 17, including one in the molten zone 21 and three in the HAZ 6. Measurements on the thickness of the flange were also carried out in the vicinity of its periphery. FIG. 5 shows the points of measurement of the hardness Hv1 and the hardnesses that were measured there.

It turns out that the metal constituting the circular portion 14 of the flange 13 has an average hardness of 386 Hv1. This hardness may present a certain dispersion, as it is usual. The hardness measured in the HAZ 6 is only slightly below this average.

The metal constituting the stiffener 17 has a relatively homogeneous hardness, between 158 and 192 Hv1, wherein the highest value is measured towards the base of the stiffener.

The hardness measured in the molten zone 21 is 208 Hv1 is thus slightly greater than the hardness of the stiffener 17, which tends to confirm that the molten zone 21 results from the diffusion of the filler metal into the metal of the support part, and that the proportion of the filler metal is predominant, in this case even very large, as is preferred to achieve a good connection of the stiffener 17 with the circular portion 14 of the flange 13.

FIGS. 6 and 7 (the latter being an enlarged portion of FIG. 6) show a micrograph of the lower portion of the stiffener 17 and its connection area with the circular portion 14 of the flange 13, after a chemical attack.

It may be seen that the stiffener 17 is composed of a superposition of layers of initially molten metal, each approximately 300-400 μm thick, and which interpenetrate over approximately 50% of their thickness. This strong interpenetration ensures that the stiffener 17 will not be particularly subject to breakage at an interface between the layers. It should be noted that in the case where formation of the stiffener 17 is not effected by deposition of powder melted by laser, but by a method of supplying molten metal by a wire 7 or a tape and a torch 8, wherein such a system would be found in the case of superposition of layers, but on a thickness that may be larger, of the order of 1 mm.

There is also a good distinction between the molten zone 21 and the HAZ 6, the thickness of which is approximately 350 μm, and which surrounds the molten zone 21 over the entire periphery thereof, including up to the surface of the circular portion 14 of the flange 13.

FIG. 8 shows another enlargement of a portion of FIG. 6, and shows the results of measurements of the hardness Hv0,1 (and not of the hardness Hv1 as in FIG. 5, as the measuring points here are closer together and are, in this case, in accordance with the standard ISO 6705, the imposed load is reduced), carried out on the longitudinal axis of the stiffener 17 in its extreme lower portion, and on the zone 21 in the extension of this axis, the HAZ 6 of the circular portion 14 of the flange 13, and a portion of the circular portion 14 of the flange 13 unaffected by the heat generated during the deposition of the metal of the stiffener 17. The measuring points are at a distance of 100 μm from one another.

There are results which qualitatively confirm those of FIG. 5 while refining them. It may be seen that at the low end of the molten zone, there is a hardness of 250 Hv0,1, as compared with about 200 Hv0,1 in the stiffener 17 and the upper portion of the molten zone, following the dilution of the metal contribution in the support part. Then, when crossing the HAZ where there has been no significant dilution of the filler metal in the metal of the flange 13, the hardness increases gradually, but it turns out that the hardness of the HAZ is not less than 20% more than the highest hardness measured in the circular portion 14 of the flange 13 at depths outside the HAZ.

The dilution of the materials into one another has also been measured in this same example of implementation of the invention. FIG. 6 shows the locations where quantitative analyses of chemical composition by scanning electron microscopy were performed. The so-called points “spectrum 9, 10, 11” are located on the stiffener 17 and are representative of its nominal composition. The so-called “spectrum 15, 16, 17” points are located in the circular portion 14 of the flange 13, and in a zone not affected chemically and thermally by the addition of molten metal, wherein they are representative of the nominal composition of the flange 13. The so-called “spectrum 12, 13, 14” points are located at the lower end of the molten zone 21, and it is possible to deduce the dilution of the materials in one another by comparing the measurements made therein, with the nominal compositions of the flange 13 and the stiffener 17 as determined by the other measurements, wherein the formula seen previously is applied for this purpose.

The results of these analyses are given in the following Table 1. Only the main contents of the Cr, Ni and Mo elements have been given in order to assess the variation of the chemical composition in the different zones of the material of the flange 13 up to the material of the stiffener 17.

The dilution of Ni as defined above is taken as a reference because the Ni content is always distinctly different in the two metals involved, is 78%. The dilutions of the other elements are, in fact, not very different from that of the Ni, which therefore appears to be quite representative of the phenomenon of dilution in general.

TABLE 1
metal compositions measured on the stiffener and the flange according to FIG. 9, and
dilution of the flange in the stiffener

| | Stiffener | | | | Molten zone | | | | Flange | | | | |
|---|---|---|---|---|---|---|---|---|---|---|---|---|---|
| | | Spectrum | Spectrum | | Spectrum | Spectrum | Spectrum | | Spectrum | Spectrum | Spectrum | | |
| | Spectrum 9 | 10 | 11 | Mean | 12 | 13 | 14 | Mean | 15 | 16 | 17 | Mean | Dilution |
| Cr % | 16.77 | 17.54 | 17.90 | 17.40 | 16.94 | 17.09 | 15.71 | 16.58 | 11.65 | 11.23 | 11.66 | 11.51 | 86% |
| Ni % | 12.34 | 12.72 | 13.64 | 12.90 | 10.21 | 10.08 | 10.32 | 10.20 | 0.11 | 0.56 | 0.60 | 0.42 | 78% |
| Mo % | 2.55 | 2.67 | 2.37 | 2.53 | 1.88 | 2.13 | 1.96 | 1.99 | 0.14 | 0.62 | traces | 0.25 | 76% |

We will now describe a reference test, in which a steel of the following composition, not in accordance with the invention, was used for the circular portion 14 of the flange 13:

| C (%) | Mn (%) | P (%) | S (%) | Si (%) | Al (%) | Ni (%) | Cr (%) | Cu (%) | Mo (%) | W (%) |
|---|---|---|---|---|---|---|---|---|---|---|
| 0.23 | 1.16 | 0.017 | 0.0006 | 0.28 | 0.057 | 0.025 | 0.17 | 0.025 | 0.006 | 0.0001 |

| Sn (%) | Nb (%) | Ta (%) | V (%) | Ti (%) | Zr (%) | Co (%) | Pb (%) | B (%) | N (%) |
|---|---|---|---|---|---|---|---|---|---|
| 0.0001 | 0.001 | traces | 0.004 | 0.04 | traces | 0.008 | traces | 0.0002 | 0.0037 |

The metal has a martensitic structure at 100% hardness 475 Hv1 but does not comply with condition B since A=8.1% and B=0.5%.

For the stiffener 17: the composition and the structure of the powder are identical and the conditions of deposition similar to that described for the test according to the invention.

The hardness in the HAZ 6 drops from 32% to 325 Hv1, i.e. a drop greater than the maximum of 20% which is typical of the invention, wherein the microstructure is no longer sufficiently martensitic (60%) and has softened by formation of bainite/ferrite/pearlite. The martensitic transformation did not compensate for the withdrawal of the molten zone. The molten zone is predominantly austenitic with a little martensite and shows a dilution of Ni very close to 80%, which proves that the condition of a dilution of Ni of 50 to 95% is not a sufficient condition to obtain good representative results of the invention. The HAZ therefore has a mechanical strength that is too low due to insufficient compression of the base of the stiffener 17. Moreover, the martensite of the molten zone is of a fragile type because it is rich in C and there is the possibility of solidification in the primary austenitic phase of the molten zone, hence the risk of hot cracking.

The example of implementation of the invention that has been presented, relating to a flange for fixing a tube is only a simple and non-limiting example. FIG. 10 shows a suspension arm 22 made from a cut and stamped preform 23, and to which stiffeners 24, 25, 26 (and others not referenced in FIG. 10) have been added by the method according to the invention.

In general, the invention may find an application in the field of the manufacture of structural parts, especially in land vehicles and aircraft, because it is easily possible to produce parts with different strength properties and optimized by weight from the same support part, only by modulating the morphology of the reinforcing elements added by the method according to the invention.

1-4. (canceled)

5. Method of manufacturing a final steel part comprising a steel support part and at least one portion formed by a method for adding a filler metal in the form of molten metal onto a portion of the surface of the support part, thus forming a heat affected zone (HAZ) on the steel support part and a molten zone between the HAZ and the portion formed by adding the molten metal, wherein:
the support part is made of a chromium steel with a microstructure which is 70-100% martensitic, in the quenched or tempered state, while the remainder of the microstructure is composed of ferrite, austenite and carbides and/or carbonitrides, the composition of which, in percentages by weight, consists of:
0.01%≤C≤1.5%;
0.01%≤N≤0.2%;
0.2%≤Mn≤1.2%;
0.2≤Si≤1.2%;
traces≤Al≤0.1%;
traces≤S+P≤0.05%;
5.0%≤Cr≤16.5%;
traces≤Ni≤3.5%;
traces≤Mo+W≤2.0%;
traces≤Cu≤3.0%;
traces≤Ti+Nb+Zr+V+Ta≤2%;
traces≤Co≤0.5%;
traces≤Sn+Pb≤0.04%;
traces≤B≤0.01%;
the remainder being iron and impurities resulting from the preparation; and meets the conditions:
A=% Mn+% Ni+% Cu+30*(% C+% N)−3*(% Ti+% Nb)≥1.5%
B=% Cr+% Mo+5*% V+% W+% Si+% Al≥9% ;
wherein the composition of the filler metal before its use consists of:
0.01%≤C≤0.1%;
0.01%≤N≤0.2%;
0.2%≤Mn≤2.0%;
0.2≤Si≤1.2%;
15.0%≤Cr≤19.0%;
6.0%≤Ni≤13.0%;
traces≤Mo+W≤3.0%;
traces≤Cu≤3.0%;
traces≤Co≤0.5%;
traces≤B≤0.01%;
traces≤S+P≤0.05%;
traces≤Ti+Nb+Zr+V+Ta≤2%;
traces≤Sn+Pb≤0.04%;
the remainder being iron and impurities resulting from the preparation;
wherein the hardness of the HAZ is not less than 20% more than that of the remaining parts of the support part, and wherein the martensite content of the HAZ is greater than or equal to equal to 70%;
and wherein the molten zone has a dilution ratio (% Ni (molten metal)−% Ni (metal support))/(% Ni (filler metal)−% Ni (metal support)) from 50 to 95% by weight.

6. Method according to claim 5, wherein the support part has a microstructure which is 90-100% martensitic.

7. Method according to claim 5, wherein the filler metal before its use contains traces≤Ti+Nb+Zr+V+Ta≤1.0%.

8. Method according to claim 5, wherein the molten zone has a dilution ratio (% Ni (molten metal)−% Ni (metal support))/(% Ni (filler metal)−% Ni (metal support)) from 75 to 85% by weight.

9. Method according to claim 5, wherein the method of adding molten metal consists of adding molten metal powder by means of a laser beam or a beam electron.

10. Method according to claim 5, wherein the method of adding molten metal comprises the addition of a molten metal from a wire whose fusion is caused by the production of an electric arc between the wire and the support part, or by a laser or by an electron beam.

11. Final steel part manufactured by the method according to claim 5, wherein at least one of the portions formed by a molten metal addition method is a reinforcing member for the support part.

12. Final steel part manufactured by the method according to claim 5, wherein at least one of the portions formed by a molten metal addition method is a reinforcing member for the support part.

13. Final steel part manufactured by the method according to claim 5, wherein at least one of the portions formed by a molten metal addition method is a reinforcing member for the support part.

14. Final steel part manufactured by the method according to claim 5, wherein at least one of the portions formed by a molten metal addition method is a reinforcing member for the support part.

15. Final steel part manufactured by the method according to claim 5, wherein at least one of the portions formed by a molten metal addition method is a reinforcing member for the support part.

16. Final steel part manufactured by the method according to claim 5, wherein at least one of the portions formed by a molten metal addition method is a reinforcing member for the support part.
